(19) United States
(12) Patent Application Publication
(10) Pub. No.: US 2026/0200759 A1
(43) Pub. Date: Jul. 16, 2026

(54) WATER PURIFIER

(71) Applicant: LG ELECTRONICS INC., Seoul (KR)

(72) Inventors: Jongwoo PARK, Seoul (KR); Myoung Hoon LEE, Seoul (KR); Ho Seon CHOI, Seoul (KR)

(21) Appl. No.: 19/134,589

(22) PCT Filed: Sep. 20, 2023
(86) PCT No.: PCT/KR2023/014252

§ 371 Date: May 30, 2025

(30) Foreign Application Priority Data
Dec. 7, 2022 (KR) 10-2022-0169708

(51) Int. Cl. C02F 1/00; C02F 1/461

(52) U.S. Cl. CPC C02F 1/001; C02F 1/46104; C02F 2201/005; C02F 2201/007; C02F 2201/46155; C02F 2209/02; C02F 2209/40; C02F 2301/043; C02F 2301/046

(57) ABSTRACT

An embodiment of the present water purifier may comprise: a first pipe through which water introduced from the outside flows; a filter disposed in the first pipe; a hot water heater into which water flows from the first pipe; a second pipe, one end of which is connected to the hot water heater; a circulation pump circulating water between the first pipe and the second pipe; a first branch pipe both ends of which are connected to the first pipe and in which the circulation pump is disposed; and a second branch pipe connecting the first pipe and the second pipe.

### TECHNICAL FIELD

The present invention relates to a water purifier, and more specifically, to a water purifier having a configuration capable of effectively sterilizing a filter and tubings.

### BACKGROUND ART

The matters described in this subsection are intended to merely provide background information regarding the present invention, and, however, would not constitute prior art.

A water purifier is an apparatus that filters raw water to remove impurities. The water purifier removes suspended solids or harmful substances contained in tap water using a filter, and purifies and discharges the desired amount of water according to the user's operation. Recent models of water purifiers can dispense not only purified water but also hot and cold water, are compact in size, and can be installed in various environments.

Within the water purifier, there are provided tubings through which water flows, and in which a filter, a valve, and the like are installed. However, if the water purifier is used for a long period of time, bacteria and microorganisms may propagate in the pipes, filters, valves, or the like. Consequently, the interior of the water purifier must be cleaned regularly.

In this regard, Republic of Korea Patent Registration No. 10-1194733 and Republic of Korea Utility Model Registration No. 0135264 have been disclosed.

Conventional technologies are related to water purifiers whose filter is sterilized using a pump and steam in the reverse direction, or using hot water.

However, conventional technologies fail to sterilize all of the water outlet tubings of the water purifier, and thus the problem still remains in that the bacteria and microorganisms continue to propagate in the tubings not subjected to the sterilization.

The water purifier may be equipped with devices to produce drinking water consumed by users, including room-temperature purified water which has passed through a filter, cold water obtained by cooling the purified water, and hot water obtained by heating the purified water.

The water purifier may have complex piping arrangements to connect these devices with the city water. Therefore, there is a need to effectively sterilize these tubings. Further, there is a need to effectively sterilize the filter and the modules of producing cold and hot water, which are disposed in the water purifier.

Furthermore, there is a need to simplify the overall structure of the water purifier by performing the sterilization using the devices necessary for the basic daily operation of the water purifier while reducing the number of devices added for the sterilization of the water purifier.

### DISCLOSURE

### Technical Problem

It is an object of the present invention to provide a water purifier having a configuration enabling the sterilization by devices necessary for the basic daily operation of the water purifier while reducing the number of devices added for the sterilization.

Also, it is an object of the present invention to provide a water purifier having a configuration capable of effectively sterilizing a filter provided in the water purifier.

Also, it is an object of the present invention to provide a water purifier having a configuration capable of effectively sterilizing every tubing in the case where the water purifier has a complex piping structure.

Also, it is an object of the present invention to provide a water purifier having a configuration capable of conveniently sterilizing a filter and a device for producing cold water.

The purposes of the present invention are not limited to the purposes mentioned above, and other purposes and advantages of the present invention which are not mentioned can be appreciated from the following description, and will be more clearly appreciated by the embodiments of the present invention. Furthermore, it is readily understood that the objects and advantages of the present invention can be achieved by the means set forth in the claims and combinations thereof.

### technical Solution

A water purifier according to one embodiment may include a filter disposed in the first pipe, a hot water heater into which water flows from the first pipe, a second tubing connected at one end with the hot water heater, a circulation pump circulating water between the first tubing and the second pipe, when the water purifier operates in a first sterilization mode, water flowing into the first tubing may be heated while passing through the hot water heater, and flow through each pipe, sterilizing it and a device provided therein.

Thus, the hot water produced using a hot water heater used to produce drinking water can be used to sterilize tubings and devices provided therein.

By causing the hot water for sterilization, which has been heated in the hot water heater, to pass through the first tubing for a set period of time, the filter disposed in the first tubing can be sterilized. Thereby, it is possible to effectively sterilize microorganisms inside the filter with a complex structure which would otherwise be difficult to sterilize.

When the water purifier operates in a third sterilization mode, the second three-way valve may open the third tubing and close the first bypass pipe, or may connect the third tubing with the first bypass tubing. Thereby, the third tubing and the first bypass tubing can be each sterilized separately.

The hot water for sterilization can sterilize the filter disposed in the first tubing while passing through the first pipe, and can also sterilize the cooling device disposed in the first bypass tubing while passing through the first bypass tubing. Thus, it is unnecessary to separate the filter and the cooling device from the water purifier for their sterilization.

An embodiment of a water purifier may include a first tubing through which water flowing in from an outside flows, a filter disposed in the first pipe, a hot water heater into which water flows from the first pipe, a second tubing connected at one end with the hot water heater, a circulation pump circulating water between the first tubing and the second pipe, a first branch tubing connected at both ends with the first pipe, and in which the circulation pump is disposed, and a second branch tubing connecting between the first tubing and the second tubing.

The water purifier may include a circulation control valve disposed in the first branch pipe, and opening or closing the first branch pipe, a first check valve disposed in the second branch pipe, and preventing water from flowing from the first tubing to the second pipe, and a second check valve disposed at a location between two points where both ends of the first branch tubing are connected to the first pipe, and preventing water flowing through the first tubing from flowing in an opposite direction to the hot water heater.

The water purifier may include a third tubing branched from the first tubing at a location between points where both ends of the first branch tubing are branched from the first pipe, and a fourth tubing connected at one end with the second tubing and the third pipe, and through which water for drinking by a user is discharged.

The water purifier may include a first three-way valve disposed in the second pipe, and a second three-way valve disposed in the third tubing.

When the water purifier operates in a first sterilization mode, water flowing into the first tubing may be heated while passing through the hot water heater, and may flow sequentially through the second branch pipe, the first pipe, the first branch pipe, and the first tubing.

When the water purifier operates in a first sterilization mode, water which has been heated by passing through the hot water heater may be repeatedly circulated through the second branch pipe, the first pipe, the first branch pipe, and the first tubing.

When the water purifier operates in a first sterilization mode, it may be provided so that the first three-way valve and the second three-way valve is closed, the hot water heater operates to heat water, and the circulation pump operates.

The water purifier may include a fifth tubing connected at one end with the first three-way valve and at another end with the third pipe, a third three-way valve disposed in the fourth pipe, and a drain tubing connected at one end with the third three-way valve.

When the water purifier operates in a second sterilization mode, water which has flowed into the first tubing may be heated while passing through the hot water heater, and then, may flow through the second pipe, the fourth pipe, and the drain pipe, and be discharged to an outside.

When the water purifier operates in a second sterilization mode, the first three-way valve may connect the second tubing with the fourth pipe, the second three-way valve may be closed, and the third three-way valve may connect the fourth tubing with the drain tubing.

The water purifier may include a first bypass tubing connected at one end with the second three-way valve and at another end with the fourth pipe, and in which a cooling device is disposed to cool water.

When the water purifier operates in a third sterilization mode, water which has flowed into the first tubing may be heated while passing through the hot water heater, and then, may flow through the second pipe, the fifth pipe, the third pipe, the first bypass pipe, the fourth pipe, and the drain pipe, and be discharged to an outside.

When the water purifier operates in a third sterilization mode, the first three-way valve may connect the second tubing with and the fifth pipe, and the third three-way valve may connect the fourth tubing with the drain tubing.

When the water purifier operates in a third sterilization mode, the second three-way valve may open the third tubing and close the first bypass pipe, or may connect the third tubing with the first bypass tubing.

The water purifier may include a second bypass tubing connected at both ends with the drain pipe, and a drain pump disposed in the second bypass pipe, and pressurizing water discharged to an outside.

The water purifier may include a washing water tubing branched from the first pipe, and allowing water which has passed through the filter to flow therethrough, a washing water valve disposed in the washing water tubing to control a flow of washing water, and an electrolyzed water module disposed in the washing water tubing to produce electrolyzed water with a use of water flowing through the washing water tubing.

Another embodiment of a water purifier may include a first tubing through which water flowing in from an outside flows, a filter disposed in the first pipe, a hot water heater into which water flows from the first pipe, a second tubing connected at one end with the hot water heater, a first branch tubing connected at both ends with the first pipe, a second branch tubing connecting between the first tubing and the second pipe, a third tubing branched from the first tubing at a location between points where both ends of the first branch tubing are branched from the first pipe, a fourth tubing connected at one end with the second tubing and the third pipe, and through which water for drinking by a user is discharged, a first three-way valve disposed in the second pipe, and a second three-way valve disposed in the third pipe, wherein when the water purifier operates in a first sterilization mode, water flowing into the first tubing may be heated while passing through the hot water heater, and may flow sequentially through the second branch pipe, the first pipe, the first branch pipe, and the first tubing.

The water purifier may include a fifth tubing connected at one end with the first three-way valve and at another end with the third pipe, a third three-way valve disposed in the fourth pipe, and a drain tubing connected at one end with the third three-way valve, wherein when the water purifier operates in a second sterilization mode, water which has flowed into the first tubing may be heated while passing through the hot water heater, and then, may flow through the second pipe, the fourth pipe, and the drain pipe, and be discharged to an outside.

The water purifier may include a first bypass tubing connected at one end with the second three-way valve and at another end with the fourth pipe, and in which a cooling device is disposed to cool water, wherein when the water purifier operates in a third sterilization mode, water which has flowed into the first tubing may be heated while passing through the hot water heater, and then, may flow through the second pipe, the fifth pipe, the third pipe, the first bypass pipe, the fourth pipe, and the drain pipe, and be discharged to an outside.

### Advantageous Effects

In the water purifier according to the present invention, the hot water produced using the hot water heater used to produce drinking water can be used to sterilize tubings and devices provided therein. Thereby, it can become unnecessary to add a device for sterilization to the water purifier, which may lead to the simplification of the structure of the water purifier, thus being capable of saving manufacturing costs and reducing the overall size of the water purifier, while at the same time effectively sterilizing the inside of the water purifier.

In the water purifier according to the present invention, the hot water passes continuously and repeatedly through the filter for a set period of time to sterilize the inside of the filter, so that microorganisms inside the filter can be effectively sterilized in spite of the complex structure of the filter which would otherwise be difficult to sterilize.

In the water purifier according to the present invention, the water purifier can sterilize a plurality of pipes, separately, using hot water. Thereby, a sufficient amount of the hot water can flow smoothly through each pipe, so that the sterilizing effect can be improved. Further, by sterilizing each tubing separately, complex tubings can be sterilized section by section, so that all tubings required to be sterilized can be effectively sterilized.

Besides, in the water purifier according to the present invention, the filter and the cooling device that are required to be sterilized can also be sterilized together with the tubings by the hot water during the process of sterilizing the tubings. Thereby, it can become unnecessary to separate the filter and the cooling device from the water purifier for the sterilization, thus being capable of increasing the convenience of sterilization procedure.

In addition to the effects described above, specific effects of the present invention will be described below together with specific matters for practicing the invention.

### DESCRIPTION OF DRAWINGS

FIG. 1 is a drawing showing the piping structure of a water purifier according to one embodiment.

FIG. 2 is a drawing for explaining the flow of hot water in the water purifier operating in the first sterilization mode.

FIG. 3 is a drawing for explaining the flow of hot water in the water purifier operating in the second sterilization mode.

FIG. 4 is a drawing for explaining the flow of hot water in the water purifier operating in the third sterilization mode.

FIG. 5 is a drawing for explaining the flow of hot water in the water purifier when sterilizing the cooling device.

FIG. 6 is a drawing for explaining the flow of hot water in the water purifier when sterilizing the third tubing.

### DETAILED DESCRIPTION

The purposes, features and advantages described above will be described in detail below with reference to the accompanying drawings, so that a person having ordinary knowledge in the technical field to which the present invention pertains can easily practice the technical idea of the present invention. In describing the present invention, if it is determined that a detailed description of a known technology related to the present invention may unnecessarily obscure the gist of the present invention, the detailed description thereof will be omitted. Hereinafter, preferred embodiments of the present invention will be described in detail with reference to the accompanying drawings. In the drawings, like reference symbols are used to refer to like or similar components.

Although the terms “first”, “second”, and so on are used to describe various components, these components are not limited by these terms. These terms are merely used to distinguish one component from another component, and unless specifically stated to the contrary, it should be understood that a first component may also be a second component.

Throughout the specification, unless specifically stated to the contrary, each element may be singular or plural.

As used herein, singular expressions include plural expressions unless the context clearly dictates otherwise. Herein, the terms “be comprised of”′ or “comprise” should not be construed to necessarily include all of the various components or various steps described in the specification, and should be construed to mean that some of the components or some of the steps may not be included, or that additional components or steps may be included.

Throughout the present document, “A and/or B” means A, B, or A and B, unless otherwise specified, and “C to D” means equal to or greater than C and equal to or smaller than D unless otherwise specified.

A water purifier according to an embodiment may provide drinking water for a user to drink, and additionally provide washing water for washing. Among the various devices installed in the water purifier, devices that require active control can have their operation controlled by a controller provided in the water purifier.

The water purifier according to an embodiment may operate in a mode such as a usage mode or a sterilization mode. In the usage mode, the water purifier may produce drinking water for drinking by users and washing water used for cleaning. In the sterilization mode, the water purifier may sterilize components building up itself, such as every tubing and a filter 120, and devices producing cold water and hot water.

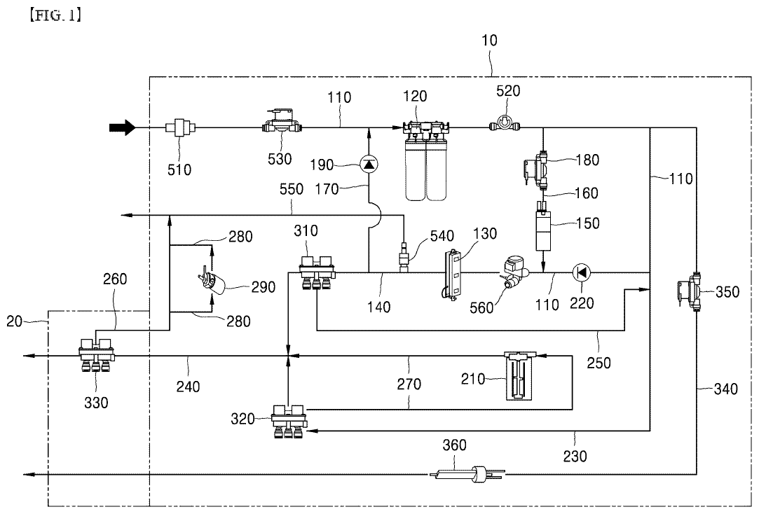

FIG. 1 is a drawing showing the piping structure of a water purifier according to one embodiment. The water purifier may include a main body 10 and a water outlet 20. The main body 10 may be equipped with devices, which filter city water flowing in from a water pipe, and cool or heat the filtered water.

From the water outlet 20 drinking water and washing water may be discharged. The water outlet 20 may be equipped with a third three-way valve 330 controlling the discharge of drinking water. The third three-way valve 330 will be described in detail later.

Hereinafter, the pipings making up the water purifier and the devices provided in the main body 10 will be described. The water purifier may include a first tubing 110, a filter 120, a hot water heater 130, a second tubing 140, a circulation pump 150, a first branch tubing 160, and a second branch tubing 170.

Through the first tubing 110 a water flowing in from the outside may flow. The first tubing 110 may be connected to a water tubing on one side and a hot water heater 130 on the other side. The first tubing 110 may be equipped with a pressure reducing valve 510 and a feed valve 530.

The pressure reducing valve 510 can reduce the pressure of raw water flowing in from the water tubing so that the water pressure of the water flowing through the water purifier can become suitable for the water purifier. Further, the pressure reducing valve 510 can stabilize the flow of water in the first tubing 110.

The feed valve 530 can control the inflow of water from the water tubing into the first tubing 110 and the water purifier. When the feed valve 530 is open, water flows into the water purifier, and when it is closed, water does not flow into the water purifier.

The filter 120 may be disposed at the first tubing 110, so that it can filter the water flowing through the first tubing 110. The filter 120 may be provided in a plural number. As the filter 120 filters the water for a user to drink, it may allow minerals necessary for the user to pass therethrough while filtering out substances harmful to human beings. The filter 120 may be provided as, for example, a carbon block filter, a UF (hollow fiber membrane) filter, or a combination thereof.

In a portion of the first tubing 110, which is adjacent to the outlet of the filter 120, a flow sensor 520 may be disposed. The flow sensor 520 may measure the flow rate of water flowing through the first tubing 110.

To one end of the first tubing 110, the hot water heater 130 may be connected, into which the water may flow from the first tubing 110. In the usage mode of the water purifier, the hot water heater 130 may heat the purified water which has passed through the filter 120 to produce hot water for the user to drink.

Meanwhile, in the sterilization mode of the water purifier, the hot water heater 130 may heat the water flowing thereinto to produce hot water for sterilization to sterilize tubings and devices. The hot water heater 130 of the embodiment may be provided as, for example, an electric heater to reduce its volume.

The method by which the hot water heater 130 produces hot water for the user to drink in the usage mode may be same as the method by which it produces the hot water for sterilization in the sterilization mode.

The second tubing 140 may be connected at one end with the hot water heater 130. The other end of the second tubing 140 may be connected to the fourth tubing 240. The water purifier may include a safety tubing 550 branching from the second tubing 140, and a safety valve 540 disposed at the safety tubing 550.

The safety tubing 550 may connect the second tubing 140 with the drain tubing 260. When the temperature or pressure of the hot water exceeds the set range, the safety valve 540 may be opened to drain the hot water discharged from the hot water heater 130 through the safety tubing 550 and the drain tubing 260 to the outside.

The circulation pump 150 may be disposed in the first branch tubing 160 to circulate water between the first tubing 110 and the second tubing 140. The circulation pump 150 may operate to circulate the hot water for sterilization through the filter 120 when the water purifier is in the sterilization mode, specifically in the first sterilization mode.

The first branch tubing 160 may be connected at both ends with the first tubing 110, and have the circulation pump 150 disposed therein. The first branch tubing 160 may be installed to allow the circulation pump 150 to be installed therein and circulate the hot water through the filter 120.

The second branch tubing 170 may connect the first tubing 110 with the second tubing 140. The second branch tubing 170 may be installed to circulate the hot water through the filter 120 together with the first branch 160.

The water purifier may include a circulation control valve 180. The circulation control valve 180 may be disposed in the first branch tubing 160 to open and close the first branch tubing 160. In the usage mode, the circulation control valve 180 is closed, so that the water does not flow through the first branch tubing 160. In the sterilization mode, the circulation control valve 180 is opened, so that the water can flow through the first branch tubing 160.

The water purifier may include a first check valve 190. The first check valve 190 may be disposed in the second branch tubing 170 to prevent water from flowing from the first tubing 110 to the second tubing 140.

Some of the water might flow from the first tubing 110 to the second tubing 140 through the second branch tubing 170 while bypassing the hot water heater 130, and would be discharged to the water outlet 20. The first check valve 190 can prevent water flowing into the first tubing 110 from flowing through the second branch tubing 170 and into the second tubing 140, so that it can avoid the phenomenon that water is not heated sufficiently in spite of the operation of the water heater 130.

The water purifier may include a second check valve 220. The second check valve 220 may be disposed at a location between two points where the both ends of the first branch tubing 160 are connected with the first tubing 110, so that it can prevent water flowing through the first tubing 110 from flowing in the opposite direction to the water heater 130.

When the first sterilization mode is in progress, water flowing from the first branch tubing 160 to the first tubing 110 might flow in the opposite direction to the hot water heater 130. The second check valve 220 can block water flowing from the first branch tubing 160 into the first tubing 110 from flowing in the opposite direction to the hot water heater 130 while allowing water to flow toward the hot water heater 130, so that it can circulate the hot water for sterilization heated by the hot water heater 130 through the filter 120 in the first sterilization mode.

In the first tubing 110 between the outlet of the first branch tubing 160 and the hot water heater 130 a flow control valve 560 may be disposed. The flow control valve 560 may control the flow rate of water flowing from the first tubing 110 to the hot water heater 130. Additionally, the flow control valve 560 may control the flow rate of hot water circulating through the filter 120 in the first sterilization mode.

The water purifier may include a third tubing 230 and the fourth tubing 240. The third tubing 230 may be branched from the first tubing 110 at a location between the points where the both ends of the first branch tubing 160 are branched from the first tubing 110.

In the usage mode, when cold water is discharged from the water outlet 20 by the user, the water which has passed through the filter 120 may flow to the third tubing 230 without passing through the hot water heater 130, may flow to the first bypass tubing 270 connected to the third tubing 230, may pass through a cooling device 210 configured to cool water, while being cooled down, and may be discharged from the water outlet 20 through the fourth tubing 240.

The fourth tubing 240 may be connected at one end with the second tubing 140 and the third tubing 230, and discharge water for the user to drink. In the usage mode, when the user wants hot water, water which has passed through the filter 120 may be heated by the hot water heater 130, and discharged from the water outlet 20 through the second tubing 140 and the fourth tubing 240.

In the usage mode, when the user wants cold water, the water may be cooled in the cooling device 210 while passing through the aforementioned flow path, and then pass through the third tubing 230 and the fourth tubing 240 to be discharged from the water outlet 20.

The water purifier may include a first three-way valve 310 and a second three-way valve 320. The three-way valve described in the specification may be coupled with three pipes, and may connect any two of the three tubings with each other or close all three tubings.

The first three-way valve 310 may be disposed in the second tubing 140. Two of the three inlets or may be referred to as outlets of the first three-way valve 310 may be connected with the second tubing 140, and the remaining one may be connected with the fifth tubing 250.

The first three-way valve 310 may connect between the second tubing 140 to allow water discharged from the water heater 130 to flow to the fourth tubing 240, or connect the second tubing 140 with the fifth tubing 250, or close the second tubing 140 and the fifth tubing 250.

The second three-way valve 320 may be disposed in the third tubing 230. Two of the three inlets or may be referred to as outlets of the second three-way valve 320 may be connected with the third tubing 230, and the remaining one may be connected with the first bypass tubing 270.

The second three-way valve 320 may connect between the third tubing 230 to allow water which has not passed through the hot water heater 130 to flow to the fourth tubing 240, or connect the third tubing 230 with the first bypass tubing 270, or close the third tubing 230 and the first bypass tubing 270.

The water purifier may include a fifth tubing 250, a third three-way valve 330, and a drain tubing 260. The fifth tubing 250 may be connected at one end with the first three-way valve 310 and at the other end with the third tubing 230.

When the water purifier operates in sterilization mode, the hot water for sterilization produced by the hot water heater 130 may flow in the third tubing 230, the first bypass tubing 270, and the cooling device 210 through the fifth tubing 250 to sterilize them.

The third three-way valve 330 may be disposed in the fourth tubing 240. Two of the three inlets or may be referred to as outlets of the third three-way valve 330 may be connected to the fourth tubing 240, and the remaining one may be connected to the drain tubing 260.

The third three-way valve 330 may connect between the fourth tubing 240 to allow drinking water consumed by the user to be discharged through the water outlet 20, or connect the fourth tubing 240 with the drain tubing 260 to allow water flowing through the fourth tubing 240 to be discharged to the outside through the drain tubing 260.

The drain tubing 260 may be connected at one end to the third three-way valve 330. In the usage mode, the water flowing through the fourth tubing 240 is water drinkable by the user. However, since the water flowing through the fourth tubing 240 in the sterilization mode is not water for drinking by the user, it is appropriate to discharge it through a different part from the drinking water outlet.

Therefore, in the water purifier according to the embodiment, hot water for sterilization flowing through the fourth tubing 240 in the sterilization mode may be discharged to the outside through the drain tubing 260 connected with the fourth tubing 240.

The water purifier may include the first bypass tubing 270 and the cooling device 210. The first bypass tubing 270 may be connected at one end with the second three-way valve 320 and at the other end with the fourth tubing 240 with the cooling device 210 disposed therein to cool water.

The cooling device 210, which is disposed in the first bypass tubing 270, may cool the purified water to produce cold water for drinking by the user in the usage mode. When the user selects cold water in the usage mode, water may be allowed to flow into the cooling device 210 through the third tubing 230 and the first bypass tubing 270, to be cooled thereby and discharged through the water outlet 20.

When the user selects filtered room temperature water, i.e. purified water, in the usage mode, the water may flow through the third tubing 230 and fourth tubing 240 without flowing into the first bypass tubing 270, and be discharged to the water outlet 20.

In the cooling device 210 a tubing may be disposed in a spiral shape, through which water flows. Thus, it is necessary to sterilize the tubing provided in the cooling device 210, and in an embodiment, by causing hot water for sterilization to flow to the cooling device 210, the tubing inside the cooling device 210 can be sterilized.

The water purifier may include a second bypass tubing 280 and a drain pump 290. The second bypass tubing 280 may be connected at both ends with the drain tubing 260. The drain pump 290 may be disposed in the second bypass tubing 280, and pressurize water discharged to the outside.

In order to quickly drain the water flowing through the fourth tubing 240, the third three-way valve 330 may connect the fourth tubing 240 with the drain tubing 260. After the fourth tubing 240 and the drain tubing 260 are connected with each other, the drain pump 290 operates, so that the water flowing through the fourth tubing 240 can be quickly discharged to the outside through the drain tubing 260.

Meanwhile, the drain pump 290 may be used when necessary for rapid drainage. Therefore, in the sterilization mode where the drain speed needs to be relatively reduced to allow hot water to remain in the tubing for a certain period of time, the drain pump 290 may not operate and water may be discharged to the outside through the drain tubing 260 in a gravity drop manner.

The water purifier may include a washing water tubing 340, a washing water valve 350, and an electrolyzed water module 360. The washing water tubing 340 may be branched from the first tubing 110, allowing the water which has passed through the filter 120 to flow therethrough. The outlet of the washing water tubing 340 may be provided in the water outlet 20. Thereby, the washing water may be discharged from the water outlet 20 of the water purifier.

Washing water is meant to contain a sterilizing substance, and in the water purifier of the embodiment, electrolyzed water containing a sterilizing substance generated in the process of electrolyzing water may be used as washing water.

The washing water valve 350 may be disposed in the washing water tubing 340 to control the flow of washing water. The electrolyzed water module 360 may be disposed in the washing water tubing 340 to produce electrolyzed water with the use of water flowing through the washing water tubing 340. The electrolyzed water module 360 may produce electrolyzed water containing a sterilizing substance by electrolyzing water that has passed through the filter 120.

In the water purifier of the embodiment, the washing water tubing 340 may not be sterilized with hot water. Since the washing water tubing 340 allows electrolyzed water containing a sterilizing substance to flow therethrough, it is sufficiently sterilized by the electrolyzed water, so there is no need to sterilize it separately using hot water.

In an embodiment, hot water produced by the hot water heater 130 which is used to produce drinking water may be used to sterilize tubings and devices provided therein. Thereby, it can become unnecessary to add a device for sterilization to the water purifier, which may lead to the simplification of the structure of the water purifier, thus being capable of saving manufacturing costs and reducing the overall size of the water purifier, while at the same time effectively sterilizing the inside of the water purifier.

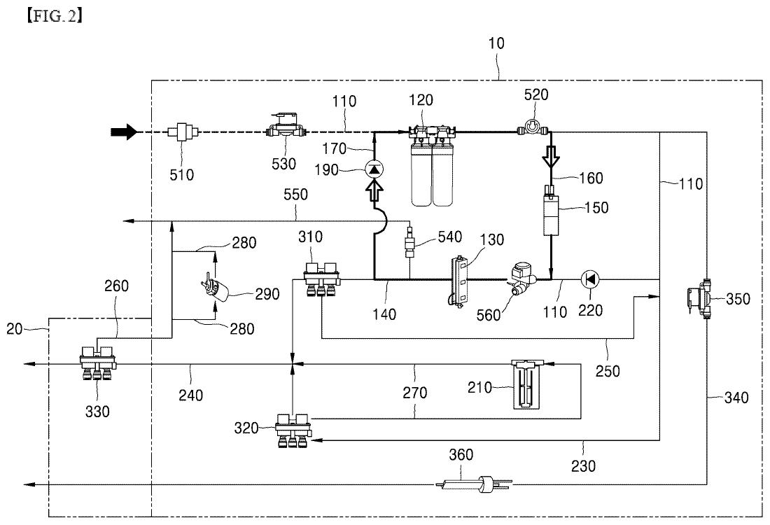

Hereinafter, the process of sterilizing the filter 120, cooling device 210 and every tubing provided in the water purifier will be specifically described with reference to the drawings. FIG. 2 is a drawing for explaining the flow of hot water in the water purifier operating in the first sterilization mode.

In FIG. 2 and the following drawings, the thick hidden lines represent the sections along which unheated water flows, and the thick solid lines represent the sections along which heated hot water flows to sterilize the tubings. Also, in FIG. 2 and the following drawings, the flows of water are shown when the water purifier operates in sterilization mode.

The first sterilization mode is a process of sterilizing the filter 120 by circulating hot water for sterilization through the filter 120. The filter 120 may be equipped with a complex structure such as a diaphragm for filtering. Due to this complex structure, microorganisms such as bacteria, viruses may grow in the inside of the filter 120, in which foreign substances serving as nutrients for the microorganisms may accumulate.

Due to this internal structure of the filter 120, the reproductive output of the microorganisms therein is greater than those in other devices of the water purifier, and, however, sterilization of the inside thereof is relatively difficult. In view of the above, the embodiment presents the continuous circulating flow of hot water for sterilization through the filter 120 and the maintaining of the circulating flow for a predetermined period of time or longer in order to sterilize microorganisms inside the filter 120 effectively.

When the water purifier operates in the first sterilization mode, water flowing into the first tubing 110 may be heated while passing through the hot water heater 130, and may flow sequentially through the second branch tubing 170, the first tubing 110, the first branch tubing 160, and the first tubing 110.

When the water purifier operates in the first sterilization mode, water which has been heated by passing through the hot water heater 130 may be repeatedly circulated through the second branch tubing 170, the first tubing 110, the first branch tubing 160, and the first tubing 110.

When the water purifier operates in the first sterilization mode, it may be provided so that the first three-way valve 310 and the second three-way valve 320 are closed, the hot water heater 130 operates to heat water, and the circulation pump 150 operates.

The first sterilization mode may proceed through the following procedures. First, the first three-way valve 310, the second three-way valve 320, and the washing water valve 350 may be closed, while the circulation control valve 180 and the feed valve 530 may be opened. Water may flow in from the water pipe, and the circulation pump 150 and the hot water heater 130 may operate.

Next, when water is sufficiently filled inside the pipe, the feed valve 530 may be closed. Whether water is sufficiently filled inside the tubing may be made known, for example, from the flow sensor 520 disposed in the first tubing 110.

When the circulation pump and the hot water heater 130 continue to operate in a state where the feed valve 530 is closed, the hot water for sterilization can be repeatedly circulated through the second branch tubing 170, the first tubing 110, the first branch tubing 160, and the first tubing 110 by the circulation pump 150. In FIG. 2, the circulation of hot water is depicted by large arrows.

The hot water can continuously and repeatedly pass through the filter 120 while being circulated. The circulation of hot water may be continued for a set period of time. As the hot water passes through the filter 120 for a set period of time, the inside of the filter 120, which has a complex structure, can be effectively sterilized by the hot water for sterilization.

In the embodiment, the hot water passes continuously and repeatedly through the filter 120 for a set period of time to sterilize the inside of the filter 120, so that microorganisms inside the filter 120 can be effectively sterilized in spite of the complex structure of the filter which would otherwise be difficult to sterilize.

Meanwhile, after the sterilization process has been completed, the first three-way valve 310 may connect between the second tubing 140, and the third three-way valve 330 may connect the fourth tubing 240 with the drain tubing 260, so that the hot water for sterilization can pass through the second tubing 140, the fourth tubing 240, and the drain tubing 260 in sequence, and be discharged to the outside.

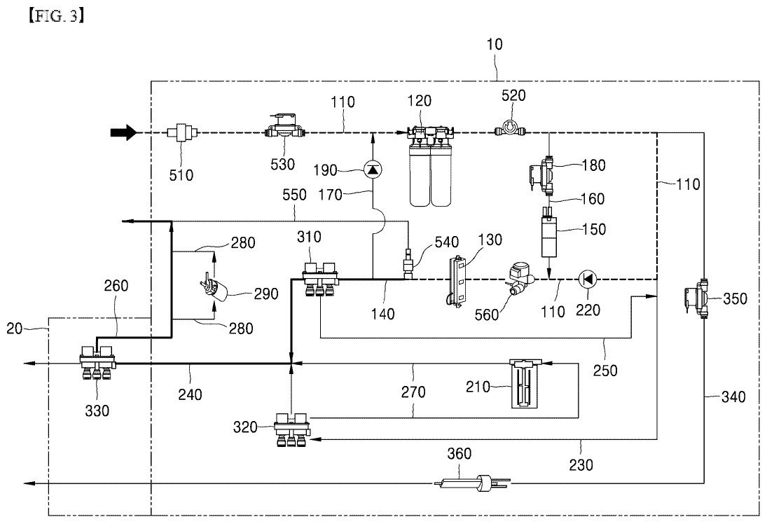

FIG. 3 is a drawing for explaining the flow of hot water in the water purifier operating in the second sterilization mode. In the second sterilization mode, the second tubing 140 and the fourth tubing 240 can be sterilized. The second tubing 140 and the fourth tubing 240 are tubings through which hot water for drinking by the user flows in the usage mode, so they need to be sterilized.

When the water purifier operates in the second sterilization mode, water which has flowed into the first tubing 110 may be heated while passing through the hot water heater 130, and then, may flow through the second tubing 140, the fourth tubing 240, and the drain tubing 260, and be discharged to the outside.

When the water purifier operates in the second sterilization mode, the first three-way valve 310 may connect the second tubing 140 with the fourth tubing 240, the second three-way valve 320 may be closed, and the third three-way valve 330 may connect the fourth tubing 240 with the drain tubing 260.

In the second sterilization mode, the circulation control valve 180 may be closed, and the circulation pump 150 may not operate. Thereby, water flowing through the first tubing 110 may not flow through the first branch tubing 160. Additionally, the first check valve 190 disposed in the second branch tubing 170 can prevent water from flowing from the first tubing 110 to the second tubing 140 through the second branch tubing 170.

Thereby, in the second sterilization mode, water which has flowed into the water purifier can flow through the first tubing 110 and pass through the hot water heater 130 to become heated hot water, and the hot water can flow through the second tubing 140 and the fourth tubing 240 while sterilizing these tubings.

The second sterilization mode may continue for a set period of time, and thus the second tubing 140 and the fourth tubing 240 can be sufficiently sterilized.

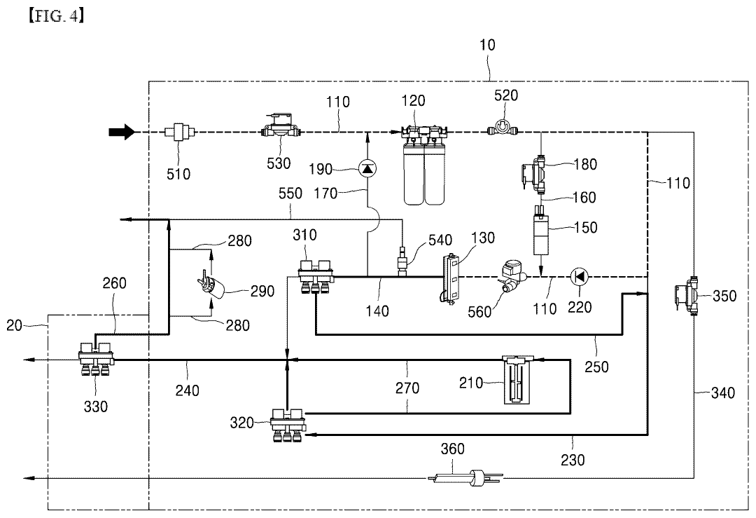

FIG. 4 is a drawing for explaining the flow of hot water in the water purifier operating in the third sterilization mode. In the third sterilization mode illustrated in FIG. 4, the water pressure of the first tubing 110 is greater than the water pressure of the fifth tubing 250, so the water discharged from the fifth tubing 250 can flow to the third tubing 230 while being sufficiently suppressed from flowing to the first tubing 110.

In the third sterilization mode, the third tubing 230 through which water that is not heated in the usage mode flows, the first bypass tubing 270 connected to the third tubing 230, and the cooling device 210 disposed in the first bypass tubing 270 may be sterilized.

When the water purifier operates in the third sterilization mode, water which has flowed into the first tubing 110 may be heated while passing through the hot water heater 130, and then, may flow through the second tubing 140, the fifth tubing 250, the third tubing 230, the first bypass tubing 270, the fourth tubing 240, and the drain tubing 260, and be discharged to the outside.

As in the second sterilization mode, in the third sterilization mode, the circulation control valve 180 may be closed, and the circulation pump 150 may not operate. Thereby, water flowing through the first tubing 110 may not flow through the first branch tubing 160. Additionally, the first check valve 190 disposed in the second branch tubing 170 can prevent water from flowing from the first tubing 110 to the second tubing 140 through the second branch tubing 170.

When the water purifier operates in the third sterilization mode, the first three-way valve 310 may connect the second tubing 140 with the fifth tubing 250, and the third three-way valve 330 may connect the fourth tubing 240 with the drain tubing 260.

In FIG. 4, all the paths through which hot water for sterilization passes in the third sterilization mode is illustrated. However, it does not mean that the second three-way valve 320 connects between the third tubing 230 while at the same time connecting the third tubing 230 with the first bypass tubing 270.

When the water purifier operates in the third sterilization mode, the second three-way valve 320 may open the third tubing 230 and close the first bypass tubing 270, or may connect the third tubing 230 with the first bypass tubing 270.

In the third sterilization mode, hot water may be used to sterilize the entire third tubing 230, and also sterilize the first bypass tubing 270 and the cooling device 210 disposed therein. The sterilization of the third tubing 230 and the sterilization of the first bypass tubing 270 and cooling device 210 may be performed sequentially, but there is no order of priority among them.

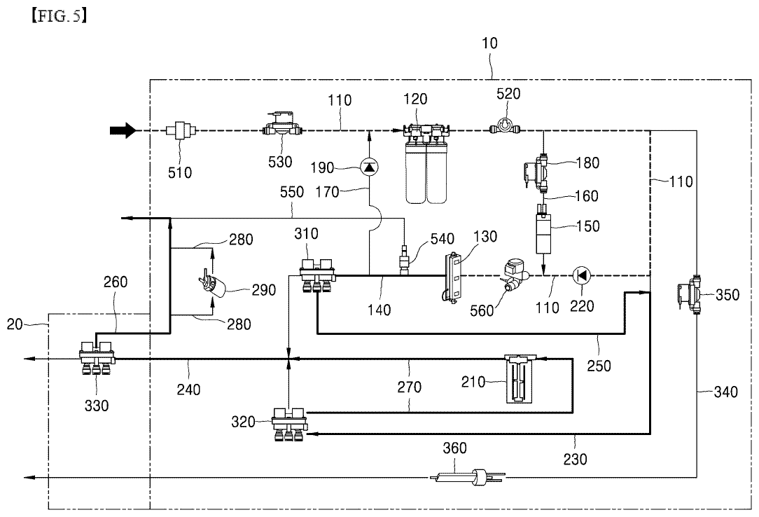

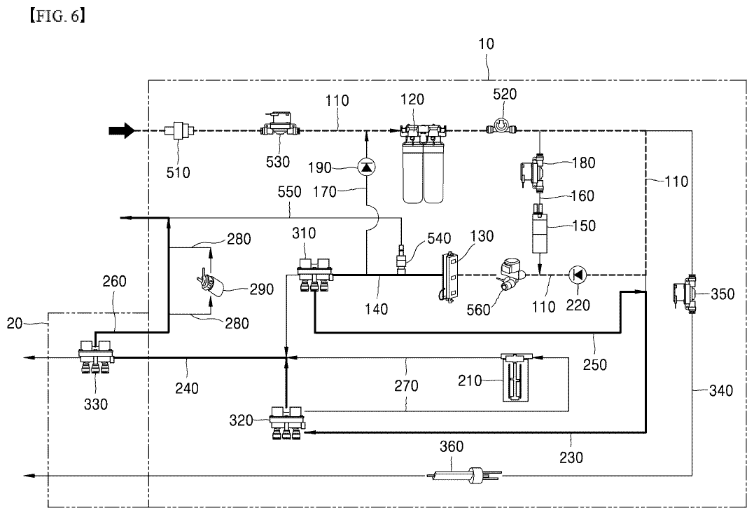

Hereinafter, this will be specifically described. In both sterilization processes illustrated in FIGS. 5 and 6 below, the fifth tubing 250 and the fourth tubing 240 may be commonly sterilized.

FIG. 5 is a drawing for explaining the flow of hot water in the water purifier when sterilizing the cooling device 210. In FIG. 5, the first bypass tubing 270 and the cooling device 210 may be sterilized using hot water for sterilization in the third sterilization mode.

In this case, the second three-way valve 320 may connect the third tubing 230 with the first bypass tubing 270. Thereby, the hot water for sterilization produced by passing through the hot water heater 130 can sequentially pass through the fifth tubing 250, the third tubing 230, and the first bypass tubing 270 while passing through the cooling device 210 disposed in the first bypass tubing 270. The hot water which has passed through the first bypass tubing 270 may be discharged to the outside through the fourth tubing 240 and the drain tubing 260.

Consequently, the cooling device 210 and the first bypass tubing 270 can be sterilized, so that the devices and tubings related to cold water consumed in the water purifier can be sterilized.

FIG. 6 is a drawing for explaining the flow of hot water in the water purifier when sterilizing the third tubing 230. In FIG. 6, the third tubing 230 may be sterilized using hot water for sterilization in the third sterilization mode.

In this case, the second three-way valve 320 may connect between the third tubing 230. Thereby, the hot water for sterilization produced by passing through the hot water heater 130 can sterilize the fifth tubing 250 and the entire third tubing 230 by passing through the third tubing 230. The hot water which has passed through the third bypass tubing 230 may be discharged to the outside through the fourth tubing 240 and the drain tubing 260.

The third sterilization mode may continue for a set period of time, and thus, the third tubing 230, the fourth tubing 240, the fifth tubing 250, the first bypass tubing 270, and the cooling device 210 can be sufficiently sterilized.

Besides, in the embodiment, the filter 120 and the cooling device 210 that are required to be sterilized can also be sterilized together by the hot water during the process of sterilizing the tubings. Thereby, it can become unnecessary to separate the filter 120 and the cooling device 210 from the water purifier for the sterilization procedure, thus being capable of increasing the convenience of sterilization procedure.

Although the present invention has been described with reference to the illustrative drawings as the above, the present invention is not limited to the embodiments and drawings disclosed in this specification, and it is obvious that various modifications can be made by those skilled in the art without departing from the scope of the technical idea of the present invention. Additionally, even if the effects related to the configuration of the present invention were not explicitly described while explaining the embodiments of the present invention, it is obvious that the effects predictable from the configuration should also be acknowledged.

1. A water purifier comprising:
a first tubing through which water flows in from outside;
a filter disposed in the first tubing;
a heater into which water flows from the first tubing;
a second tubing connected at one end with the hot water heater;
a first branch tubing connected at both ends with the first tubing, and in which a circulation pump is disposed; and
a second branch tubing that connects the first tubing with the second tubing.

2. The water purifier of claim 1, comprising:
a circulation control valve disposed in the first branch tubing, and that opens and closes the first branch tubing;
a first check valve disposed in the second branch tubing, and that prevents water from flowing from the first tubing to the second tubing; and
a second check valve disposed on a portion of the first tubing between two points where ends of the first branch tubing are connected to the first tubing, and that prevent water in the first tubing from flowing in direction away from the hot water heater.

3. The water purifier of claim 1, comprising:
a third tubing having an end connected to a portion of the first tubing between two points where ends of the first branch tubing are connected to the first tubing; and
a fourth tubing connected at one end with the second tubing and the third tubing, and having a second end through which water is discharged.

4. The water purifier of claim 3, comprising:
a first three-way valve disposed in the second tubing; and
a second three-way valve disposed in the third tubing.

5. The water purifier of claim 4, wherein when the water purifier operates in a first sterilization mode, water from the first tubing is heated while passing through the hot water heater, and the heated water then flows sequentially through the second branch tubing, the first tubing, the first branch tubing, and the first tubing.

6. The water purifier of claim 4, wherein when the water purifier operates in a first sterilization mode, water which has been heated by passing through the hot water heater is repeatedly circulated through the second branch tubing, the first tubing, the first branch tubing, and the first tubing.

7. The water purifier of claim 4, wherein when the water purifier operates in a first sterilization mode, the first three-way valve and the second three-way valve are closed, the hot water heater operates to heat water, and the circulation pump operates.

8. The water purifier of claim 4, comprising:
a fifth tubing connected at one end with the first three-way valve and at another end with the third tubing;
a third three-way valve disposed in the fourth tubing; and
a drain tubing connected at one end with the third three-way valve.

9. The water purifier of claim 8, wherein when the water purifier operates in a second sterilization mode, water from the first tubing is heated while passing through the hot water heater, and then, the heated water flows through the second tubing, the fourth tubing, and the drain tubing, to be discharged to an outside.

10. The water purifier of claim 8, wherein when the water purifier operates in a second sterilization mode, the first three-way valve connects the second tubing with the fourth tubing, the second three-way valve is closed, and the third three-way valve connects the fourth tubing with the drain tubing.

11. The water purifier of claim 8, comprising:
a first bypass tubing connected at one end with the second three-way valve and at another end with the fourth tubing, and in which a cooling device is disposed.

12. The water purifier of claim 11, wherein when the water purifier operates in a third sterilization mode, water from the first tubing is heated while passing through the hot water heater, and then, the heated water flows through the second tubing, the fifth tubing, the third tubing, the first bypass tubing, the fourth tubing, and the drain tubing to be discharged to an outside.

13. The water purifier of claim 11, wherein when the water purifier operates in a third sterilization mode, the first three-way valve connects the second tubing with and the fifth tubing, and the third three-way valve connects the fourth tubing with the drain tubing.

14. The water purifier of claim 11, wherein when the water purifier operates in a third sterilization mode, the second three-way valve opens the third tubing while closing the first bypass tubing, or connects the third tubing with the first bypass tubing.

15. The water purifier of claim 8, comprising:
a second bypass tubing connected at both ends with the drain tubing; and
a drain pump disposed in the second bypass tubing, and configured to cause pressurizing water discharged to an outside.

16. The water purifier of claim 1, comprising:
an electrolyzed water tubing branched from the first tubing, and through which water which has passed through the filter;
an electrolyzed water valve disposed in the electrolyzed water tubing to control a flow of water; and
an electrolyzed water module disposed in the electrolyzed water tubing to produce electrolyzed water with water flowing through the electrolyzed water tubing.

17. A water purifier comprising:
a first tubing through which water flows from outside;
a filter disposed in the first tubing;
a hot water heater into which water flows from the first tubing;
a second tubing connected at one end with the hot water heater;
a first branch tubing connected at both ends with the first tubing;
a second branch tubing connecting to the first tubing and the second tubing;
a third tubing branched from the first tubing between points where ends of the first branch tubing are connected to the first tubing;
a fourth tubing connected at one end with the second tubing and the third tubing, and through which water is discharged;
a first three-way valve disposed in the second tubing; and
a second three-way valve disposed in the third tubing,
wherein when the water purifier operates in a first sterilization mode, water flowing in the first tubing is heated while passing through the hot water heater, and then flows sequentially through the second branch tubing, the first tubing, the first branch tubing, and the first tubing.

18. The water purifier of claim 17, comprising:
a fifth tubing connected at one end with the first three-way valve and at another end with the third tubing;
a third three-way valve disposed in the fourth tubing; and
a drain tubing connected at one end with the third three-way valve,
wherein when the water purifier operates in a second sterilization mode, water flowing in the first tubing is heated while passing through the hot water heater, and then, the heated water flows through the second tubing, the fourth tubing, and the drain tubing to be discharged to an outside.

19. The water purifier of claim 18, comprising:
a first bypass tubing connected at one end with the second three-way valve and at another end with the fourth tubing, and in which a cooling device is disposed,
wherein when the water purifier operates in a third sterilization mode, water flowing in the first tubing is heated while passing through the hot water heater, and then, the heated water flows through the second tubing, the fifth tubing, the third tubing, the first bypass tubing, the fourth tubing, and the drain tubing to be discharged to an outside.

20. The water purifier of claim 1, wherein the second branch tubing connects to the first tubing upstream of the filter.
